(19) United States
(12) Patent Application Publication
(10) Pub. No.: US 2002/0007660 A1
(43) Pub. Date: Jan. 24, 2002

(54) Piezoelectric cable sensor having remote monitoring self test capability

(76) Inventor: Richard Hunter Brown, Dreieich (DE)

Correspondence Address: Edward J. Howard, Esq., Duane, Morris & Heckscher LLP, 100 College Road West, Suite 100, Princeton, NJ, 08540, US

(21) Appl. No.: 09/854,792

(22) Filed: May 14, 2001

Related U.S. Application Data
(60) Provisional application No. 60/203,547, filed on May 12, 2000.

(51) Int. Cl. G01N 29/00

(52) U.S. Cl. 73/1.82; 367/13

(57) ABSTRACT

A sensor system comprising two or more electrically-independent piezoelectric cables, secure at intervals to a common rigid or semi-rigid structure or to themselves and spaced apart from one another, with one cable at any given instant coupled to an electrical drive signal and acting as a transmitter, the other cable or cables acting as a receiver and connected to electronic detection circuitry, such that a mechanical vibration signal is launched by the transmitter and detected by the receiver to enable the detection function of the other cable or cables as receivers to be checked.

### CROSS-REFERENCE TO RELATED APPLICATI0NS

This application claims priority from copending U.S. Provisional Patent Application Ser. No. 60/203,547 filed May 12, 2000, entitled “Piezoelectric Cable Sensor Having Remote Monitoring Self Test Capability” which is incorporated herein by reference in its entirety and for all purposes.

### FIELD OF THE INVENTI0N

The present invention relates to sensor systems in general, and more particularly, to piezoelectric cable sensors having self testing capabilities.

### BACKGROUND OF THE INVENTION

The use of piezoelectric cable (or piezo cable) as a perimeter security sensor is well known. Present commercially available systems use piezo cable, secured at intervals to a rigid or semi-rigid structure such as a fence, to detect acoustic signals on the fence. For example, the piezo cable structure may operate to detect acoustic signals generated by the act of climbing or cutting the fence, thus operating as an alarm or intrusion detection system. The piezo cable may be secured to the fence using cable ties or other fastenings, as is understood. Typically, application of a perimeter security sensor system (e.g. piezo cable attached to a fence) requires multiple runs of sensor cables, as the detection range of a single cable may be limited along its vertical axis. For example, one length of piezo cable may be disposed on a portion of the fence close to the ground in order to detect a acoustic vibrations impacting that general area, while another length of piezo cable or “run” may be mounted on the fence at a position higher up so as to be vertically separated from the lower run by a predetermined distance.

Efforts to diagnose the “health” or status condition of a piezoelectric sensor cable are usually limited to the use of a single terminating resistor, fitted to the “far end” of a cable run. The presence or absence of this DC resistance path across the sensor element may be easily checked. Cutting the sensor cable breaks the DC resistance path. However, such a test does not truly indicate whether the sensor cable is functioning correctly. A system and method that provides for determining or verifying the sensitivity and functionality of a piezo cable sensor system on a continuous, periodic or “on demand” basis is desired.

### SUMMARY OF THE INVENTI0N

A system comprising two or more electrically-independent piezoelectric cables, secured at intervals to a common rigid or semi-rigid structure with a substantially constant but arbitrary spacing apart, with one cable at any given instant acting as a transmitter (connected to an electrical drive signal) and the other(s) acting as receiver(s) connected to electronic amplifiers, such that a mechanical vibration signal is launched by the transmitter and picked up by the receiver(s), allowing the detection function of the receivers to be checked continously or intermittently.

A method for remotely monitoring a sensor system comprising two or more electrically-independent piezoelectric cables, secured at intervals to a common rigid or semi-rigid structure or to themselves and spaced apart from one another, comprises driving one of the cables with a test signal to cause the cable to operate as a transmitter to transmit an acoustic signal indicative of the test signal; and monitoring the output of at least another one of the cables to determine whether the at least one other cable detects the acoustic signal resulting from the drive signal.

In a security system comprising two or more electrically-independent piezoelectric cables, secured at intervals to a common rigid or semi-rigid structure or to themselves and spaced apart from one another for detecting vibrational signals incident thereon indicative of an intrusion attempt and transmitting an electrical signal in response thereto, and a detection circuit coupled to the piezoelectric cables for comparing the electrical signal received from the detecting cable with a threshold value to determine whether or not an intrusion attempt has occurred, a method for remotely monitoring the integrity of the security system comprises driving one of the cables with a test signal to cause the cable to operate as a transmitter to transmit an acoustic signal indicative of the test signal; and monitoring the output of at least another one of the cables to determine whether the at least one other cable detects the acoustic signal resulting from the drive signal. The monitoring step comprises analyzing the spectral content of the detected signal to determine correspondence to the test signal. The test signal may have an amplitude that is sufficiently less than the intrusion detection threshold so as to enable simultaneous intrusion detection and integrity monitoring. The test signal may have a bandwidth outside the bandwidth associated with determining an intrusion detection so as to enable simultaneous intrusion detection and integrity monitoring. In order to monitor the integrity of each of the two or more piezoelectric cables, the driving and monitoring functions may be selectively switched between the two or more cables in a predetermined manner.

### BRIEF DESCRIPTION OF THE DRAWINGS

FIG. 1 is a Time-domain plot of a drive signal associated with the system in accordance with the present invention.

FIG. 2 is illustrative of a Time-domain plot of a received signal associated with the system in accordance with the present invention.

FIG. 3 is illustrative of a Frequency-domain plot of a drive signal associated with the system in accordance with the present invention.

FIG. 4 is illustrative of a Frequency-domain plot of a received signal associated with the system in accordance with the present invention.

FIG. 5 is an exemplary schematic representation of the piezoelectric cable mounted onto a fence structure in accordance with the present invention.

FIG. 6 is an exemplary schematic circuit representation of the piezoelectric cable sensor system in accordance with the present invention.

FIG. 7 is an exemplary illustration of a test signal applied to a length of piezoelectric cable operative as a transmitter in accordance with the present invention.

### DETAILED DESCRIPTI0N OF THE INVENTI0N

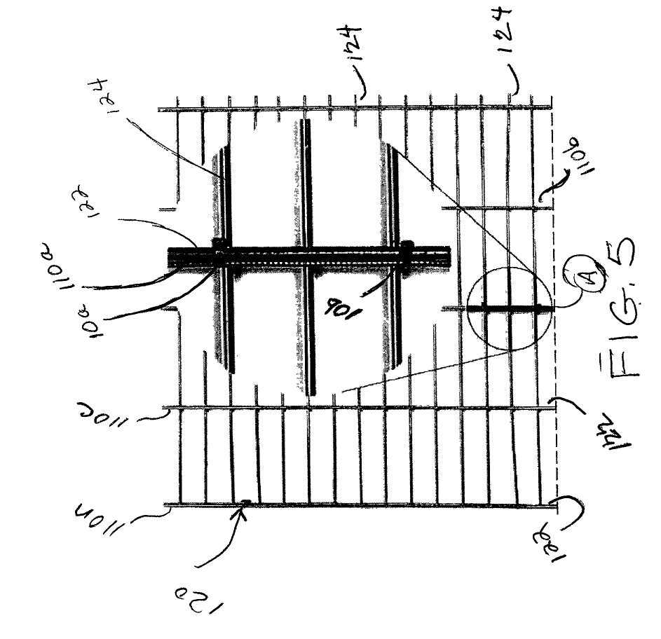

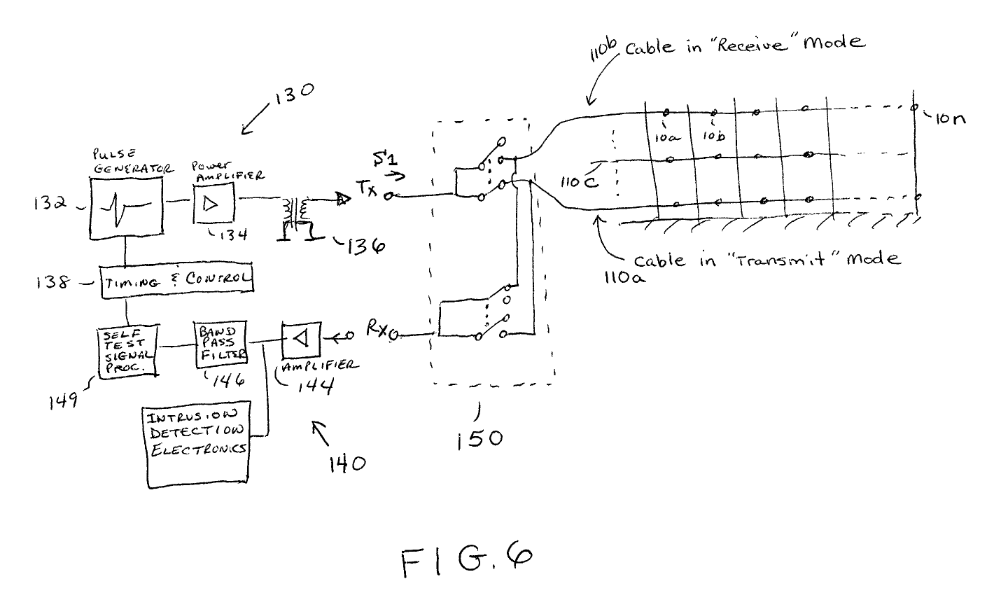

Referring generally to the drawings, wherein like reference numerals are used to indicate like parts, and in particular to FIGS. 5 and 6, there is illustrated a security sensor system 100 comprising series of (i.e. two or more) of similar lengths of piezoelectric cable, 110a, 110b, . . . 110n fastened to a rigid or semi-rigid structure 120 such as a fence at points 10a, 10b, . . . 10n along their respective lengths. At any instant, one cable, for example cable 110a, may be designated as a “transmitter” and the other cable or cables (for example 110b . . . 110n) operative as a receiver(s). As shown in FIG. 5, fence 120 comprises a series of vertical column sections 122 spaced apart from one another at substantially uniform intervals and interconnected via the series of horizontal row sections 124 also spaced apart from one another at substantially uniform predetermined intervals. A portion of the fence structure shown in FIG. 5 is provided in greater detail as reference numeral A, which illustrates a length of piezoelectric cable 110a coupled to fence structure 120 along one of the vertical column sections 122 and fastened together via conventional fasteners or cable ties at points 10a and 10b. A drive circuit 130 comprising for example, a pulse generator 132 (e.g. impulse, continuous wave, or burst of cycles) coupled to an amplifier 134 and step-up transformer 136 is operative to generate an electrical signal S1 at an appropriate amplitude and frequency, and applied to the transmitter cable 110a. By virtue of the piezoelectric effect, a mechanical vibration is created by the transmitter, which is coupled into the fence structure. The other piezoelectric cable or cables are operative as receiver(s) for detecting the acoustic event in the fence, and the resulting signals output therefrom may be amplified and filtered via detection circuitry 140 as necessary to create a final signal indicative of whether or not the system is functioning correctly.

FIG. 6 provides an exemplary embodiment of the integrity detection system and method according to the present invention. A switching mechanism 150 is coupled at a first port to the drive circuitry 130 and at a second port to the detection circuitry 140. The switching mechanism is further coupled at third and fourth ports respectively to each of the piezocables which are operative as either transmitters or receivers. The switching mechanism 150 may be implemented in a variety of ways well known to those skilled in the art including for example, electrical throw switches, couplers, or multiplexers. Other analog and digital switching circuitry well known to those skilled in the art is also contemplated for use as switching mechanism 150. The switching mechanism operates to selectively couple at least one of the lengths of cable to the drive circuitry 130 and at least one of the other lengths of cable to the detection circuitry so as to perform integrity testing or self-testing of the system. The switching mechanism may be controlled via conventional timing and control circuitry 138 for example, so as to periodically switch which of the cable or cables are operative as a transmitter and which of the cable or cables are operative as a receiver. As is understood, timing and control module 138 operates to drive the transmitting signal S1 at a predetermined interval or rate consistent with the detection processing electronics 140 to provide periodic, on-demand, or substantially continuous cable testing, for example. Thus, as shown in FIG. 6, the transmit and receive functions may be switched between cables, periodically or upon demand.

The security system and method of the present invention thus allows for the normal intrusion detection process to occur substantially unimpeded, while providing for simultaneous system integrity checking and verification. That is, switching mechanism 150 is operative to couple a mulitplicity of piezocables to be operative as receivers. In “normal” intrusion detection mode, the receiver circuitry 140 includes intrusion detection electronics module 148 comprising conventional signal processing electronics operative to process the outputs from the receiver sensor cables to determine whether the vibrational signals detected therefrom are indicative of an intrusion attempt. This may be accomplished by comparing the electrical signal or signals received from the detecting cables with a threshold value. If the received signals are less than the threshold, no intrusion attempt has occurred. Conversely, if the signals exceed the threshold value, the system is operable to identify this event as an intrusion detection. In accordance with the present invention, however, the system is also operable in a “test” or integrity verification mode. That is, by driving one (or more) of the piezocables with the drive or test signal S1 from pulse generator 132 having an amplitude substantially less than the amplitude associated with the threshold value indicative of intrusion detection, but nevertheless of sufficient amplitude to generate a detectable response from the receiver cable(s), the output of the receiver cables may be monitored via conventional signal processor circuitry associated with modules 144, 146 and electronics module 149 (for performing integrity verification) to detect the acoustic signal resulting from the drive signal without impacting the intrusion detection processing. Thus, the integrity verification detection circuitry is operative to receive the output from the piezocables, filter the output to obtain appropriate amplitude and frequency characteristics for signal processing, and compare the filtered signal with the input drive signal in accordance with the timing and electronic control circuitry 138 in order to determine appropriate responsiveness of the receiver cable(s) in self-test mode. Therefore, in a manner similar to that described above with respect to normal intrusion detection mode, the system is operative to process the outputs from the receiver sensor cables to determine whether the vibrational signals detected from the test signal are received by the detecting cables at a value greater than a threshold value to signify appropriate cable responsivity to the test signal. It is of course noted that the transmitting cable operative for transmitting the test signal S1 may not be used as a receiver in the detection process, however, it is comtemplated that, particularly for multiple lengths of piezoelectric cable attached to a rigid or semi-rigid structure, this would not significantly affect normal operation of the detection system. Note further that simultaneous processing of the system as both an intrusion detection system and an integrity verification system may also be accomplished by operating the test signal at a bandwidth outside that of the bandwidth typically associated with an intrusion detection. In this manner, the self-test detection circuitry may be tuned for particular frequencies received as a result of the vibrational characteristics resulting from the transmitted signal S1 (and the frequency response of the structure) so as to determine the integrity of each of the cables. In this manner, it is contemplated that the transmitting cable may also be operative as a receiver cable so as to operate in a “normal” intrusion detection mode.

In practice, the acoustic event which is generated by the transmitter in response to the driving electrical excitation or test signal is rather weak (that is, below the amplitude level which may be classified as an intrusion attempt), and so the signals do not interfere with the normal detection process. Further, the acoustic output may be below or above perceptibility by humans —if arranged to be perceptible, then the presence of a security system is indicated to a potential intruder and may act as a form of deterrent.

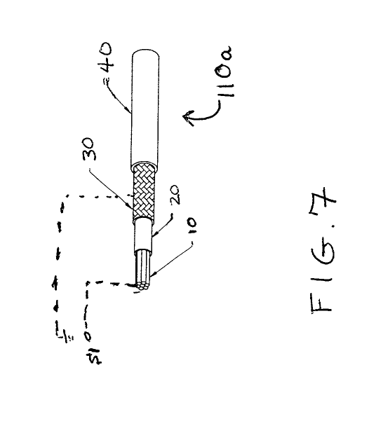

FIG. 7 is an exemplary illustration of a piezoelectric cable 110A operative as a transmitter for transmitting an acoustic signal for detection by other piezoelectric cables electrically independent of one another and physically separated from one another on the fence structure depicted in FIGS. 5 and 6. As shown in FIG. 7, piezo-polymer cable 110A may be designed as a coaxial cable wherein the piezo-polymer material 20 represents the dielectric between the stranded center core 10 and an outer copper braid shield 30. An outer jacket 40, comprising for example, a polyethylene material is applied to the braid shield to further protect the cable. Typical cable of this type may be a 20 AWG piezocable produced by Measurement Specialties Inc. The electrical excitation voltage test signal S1 is applied between the core 10 and braid 30 for creating a potential voltage so as to cause mechanical vibration within the cable coupled to the fence structure. The system may work in conjunction with the resistive termination method mentioned above.

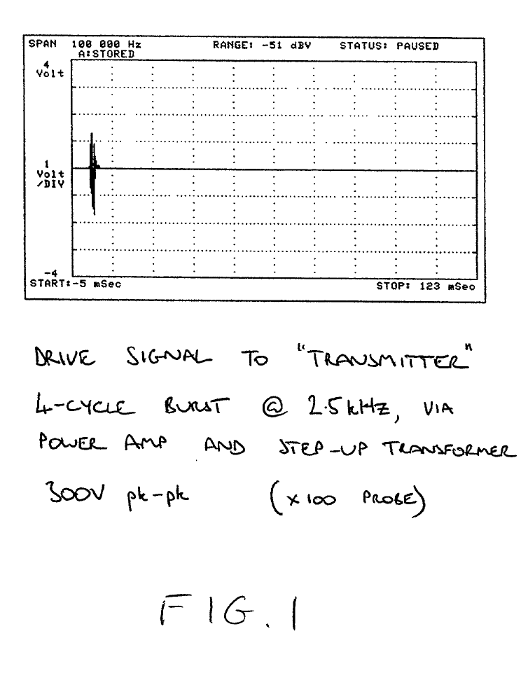

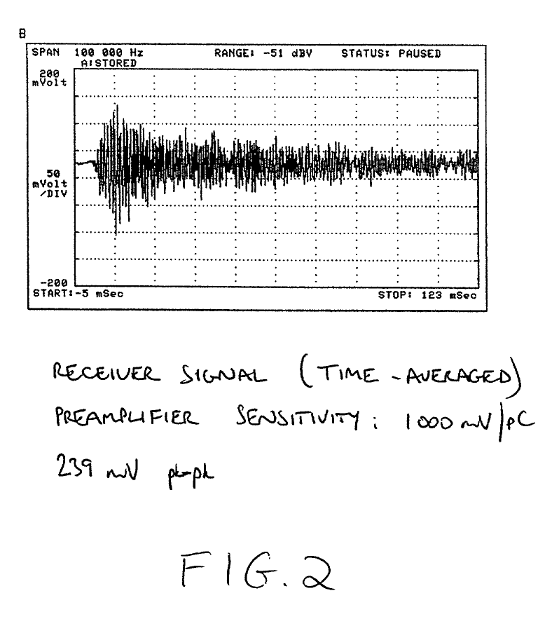

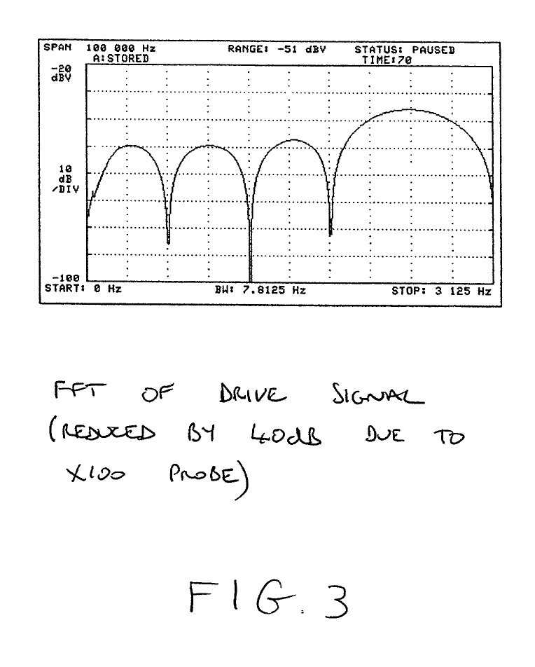

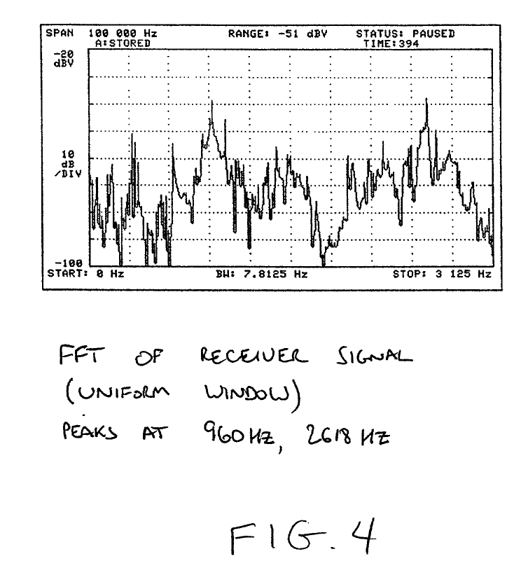

On typical rigid fence structures, a certain band of frequencies will be transmitted strongly. The frequency band depends upon the detailed structure of the fence, but will typically fall in the 500 to 5,000 Hz region. A drive signal may be applied which contains significant energy within this band. A single pulse or burst of pulses, where the nominal frequency of the pulse(s) lies within this band (e.g around the midpoint of the band), will create an excitation signal which is reasonably broadband and does not require individual tuning depending upon the exact fence structure. An example of an excitation signal, and the corresponding response detected from a fence, is depicted in FIGS. 1-4. The time-domain response (FIG. 2) is rather complex, due to the multitude of possible paths for the vibration signal, and the multiple resonances within the structure. An FFT transform of the receiver signal (FIG. 3) reveals much energy in the 600 to 3000 Hz region.

It should be noted that although the cable sensors were tested spaced apart on a rigid fence, a similar response is obtained if two cables are cable-tied together, even if these are lying in free space (or buried underground, for example). Two short lengths, only coupled by three cable ties, have been tested and detected good response. The above has possible utility when considering a buried system, as only the transmitted signal bandwidth and amplitude may change. In this case, the “common substrate” would then become the simple assembly of the two cables, which may be influenced by damping introduced by soil or ground conditions, for example.

Advantageously, the system according to the present invention checks that both transmitter and receiver cables are truly sensitive (i.e. piezo-electrically active) on a continuous, periodic, or “on demand” basis. As more than one cable is commonly deployed on fence security systems, the present invention requires only a hardware change in the installation. Moreover, the system can be used in conjunction with DC resistance test strategy.

It is understood that the invention as described herein is applicable to but in no way limited to fence-mounted perimeter security systems.

While the foregoing invention has been described with reference to the above embodiments, various modifications and changes can be made without departing from the spirit of the invention. For example, while FIG. 5 shows lengths of piezoelectric cable substantially parallel to one another and vertically oriented, FIG. 6 illustrates similarly situated lengths of cable which are arranged horizontally along the fence but in a vertically stacked manner. Other geometric configurations as well as other orientations are also contemplated and are intended to be within the scope of this invention. Accordingly, all such modifications and changes are considered to be within the scope of the appended claims.

What is claimed is:

1. A sensor system comprising:
a first length of piezoelectric cable secured to a first portion of a rigid or semi-rigid structure;
a second length of piezoelectric cable secured to a second portion of a rigid or semi-rigid structure; wherein the first and second lengths of piezoelectric cable are electrically independent of one another and physically separated from one another;
a drive circuit selectively coupled to the first length of cable for transmitting a drive signal to the first length to cause the first length to transmit acoustic signals; and
a processor selectively coupled to the second length of cable for receiving signals detected by the second length of cable in response to the acoustic signals transmitted by the first length of cable to determine responsivity of the second length of cable.

2. The system of claim 1, wherein the drive signal includes spectral frequencies ranging between 500 Hz and 5000 Hz.

3. The system of claim 1, further comprising a controller for controlling the rate at which the drive circuit transmits the drive signal.

4. The system of claim 1, further comprising a switching mechanism first and second ports in electrical communication with the drive circuit and the processor, respectively, and third and fourth ports in electrical communication with the first and second lengths of cable, respectively, for selectively switching the communication paths of the first and second lengths of cable with the drive circuit and processor to enable switching of the transmitter and receiver functions of the first and second lengths of cable.

5. The system of claim 4, wherein the switching is performed on a periodic basis.

6. The system of claim 4, wherein the switching is performed on a non-periodic basis.

7. A sensor system comprising:
two or more electrically-independent piezoelectric cables, secure at intervals to a common rigid or semi-rigid structure or to themselves and spaced apart from one another, with one cable at any given instant coupled to an electrical drive signal and acting as a transmitter, the other cable or cables acting as a receiver and connected to electronic detection circuitry, such that a mechanical vibration signal is launched by the transmitter and detected by the receiver to enable the detection function of the other cable or cables as receivers to be checked.

8. The system of claim 7, wherein the one cable operating as a transmitter is driven continuously to provide continuous checking of the receiver cable or cables.

9. The system of claim 7, wherein the one cable operating as a transmitter is driven intermittently to provide intermittent checking of the receiver cable or cables.

10. The system of claim 7, further comprising a switching mechanism for switchably coupling respective ones of the two or more piezoelectric cables to the corresponding electrical drive signal and electronic detection circuitry to selectively check the detection function of each of the two or more piezoelectric cables.

11. A method for remotely monitoring a sensor system comprising two or more electrically-independent piezoelectric cables, secured at intervals to a common rigid or semi-rigid structure or to themselves and spaced apart from one another, said method comprising:
driving one of the cables with a test signal to cause the cable to operate as a transmitter to
transmit an acoustic signal indicative of the test signal; and
monitoring the output of at least another one of the cables to determine whether the at least
one other cable detects the acoustic signal resulting from the drive signal.

12. The method of claim 11, wherein the step of monitoring comprises amplifying and processing responses from the at least one other cable and comparing with the test signal to determine signal detection.

13. The method of claim 11, further comprising the step of selectively switching the driving and monitoring functions of the two or more piezoelectric cables in a predetermined manner to selectively monitor each of the two or more piezoelectric cables.

14. The method of claim 11, wherein the step of driving one of the cables comprises transmitting an electrical drive signal comprising at least one electrical pulse of a given amplitude and frequency to cause the one cable to transmit the acoustic signal; and
wherein the step of monitoring comprises receiving the output from another one of the cables, filtering the output to obtain a filtered signal characteristic of an amplitude and frequency range, and comparing the filtered signal with the drive signal.

15. The method of claim 14, wherein the step of filtering further comprises performing spectral processing of the received output.

16. In a security system comprising two or more electrically-independent piezoelectric cables, secured at intervals to a common rigid or semi-rigid structure or to themselves and spaced apart from one another, for detecting vibrational signals incident thereon indicative of an intrusion attempt and transmitting an electrical signal in response thereto, and a detection circuit coupled to the piezoelectric cables for comparing the electrical signal received from the detecting cable with a threshold value to determine whether or not an intrusion attempt has occurred, a method for remotely monitoring the integrity of the security system comprising:
driving one of the cables with a test signal to cause the cable to operate as a transmitter to transmit an acoustic signal indicative of the test signal; and
monitoring the output of at least another one of the cables to determine whether the at least one other cable detects the acoustic signal resulting from the drive signal.

17. The method of claim 16, wherein the step of monitoring comprises analyzing the spectral content of the detected signal to determine correspondence to the test signal.

18. The method of claim 16, wherein the test signal has an amplitude sufficiently less than the intrusion detection threshold to enable simultaneous intrusion detection and integrity monitoring.

19. The method of claim 16, wherein the test signal has a bandwidth outside the bandwidth associated with determining an intrusion detection so as to enable simultaneous intrusion detection and integrity monitoring.

20. The method of claim 16, further comprising the step of selectively switching the driving and monitoring functions of the two or more piezoelectric cables in a predetermined manner to selectively monitor the integrity of each of the two or more piezoelectric cables.

21. A sensor system comprising:
a first length of piezoelectric cable secured to a first portion of a rigid or semi-rigid structure;
a second length of piezoelectric cable secured to a second portion of a rigid or semi-rigid structure; wherein the first and second lengths of piezoelectric cable are electrically independent of one another and physically separated from one another;
a drive circuit for transmitting a test signal to one of the first or second lengths of piezoelectric cable;
a processor for receiving an output from the other one of the first or second lengths of piezoelectric cable and comparing with a predetermined threshold to determine the responsivity of that length of cable; and
a switching mechanism for selectively coupling one of the first and second lengths of piezoelectric cable to the drive circuit and the other length of piezoelectric cable to the processor for enabling acoustic signals transmitted by the length of piezoelectric cable coupled to the drive circuit in response to the test signal to be detected by the length of cable coupled to the processor.
